(19) United States
(12) Patent Application Publication
(10) Pub. No.: US 2010/0203368 A1
(43) Pub. Date: Aug. 12, 2010

(54) RECHARGEABLE BATTERY

(76) Inventor: Wolf Matthias, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/668,574

(22) PCT Filed: May 19, 2008
(86) PCT No.: PCT/EP08/56112

§ 371 Date: Mar. 31, 2010

(30) Foreign Application Priority Data
Jul. 9, 2007 (DE) 102007031857.1

(51) Int. Cl. H01M 10/48; H01M 10/05

(52) U.S. Cl. 429/90; 429/160

(57) ABSTRACT

The invention relates to a rechargeable battery for handheld, electromechanical tools, with a plurality of rechargeable battery cells, which are electrically connected to one another by means of electrical cell connectors. At least one cell connector has an electrical insulation, and an electronic component such as a set of accumulator-protecting electronics or a sensor, is provided on or in the electrical insulation.

### PRIOR ART

The invention relates to an accumulator for hand-held electromechanical tools; the accumulator has a plurality of accumulator cells that are electrically connected to one another. The invention also relates to an electromechanical tool equipped with an accumulator according to the invention.

The term “electromechanical tools” refers to all hand-held, portable, electrically operated hand tools in which a motor constitutes a usually inseparable component of the tool. It relates, for example, to power drills, cordless screwdrivers, circular saws, jigsaws, angle grinders, other grinding machines, and, depending on their design, various garden appliances such as electric hedge trimmers. Accumulators and batteries for these tools should have the highest possible capacity, the lowest possible weight, take up the least possible amount of space, and should also be inexpensive to manufacture.

In particular, accumulators or battery packs for electromechanical tools with high energy demands should be rechargeable in the shortest possible amount of time in order, when used in alternation with a second accumulator, to achieve a virtually continuous use of the tool. In order to achieve a sufficient service life of the accumulators, it is necessary to take into account specific limit values of the accumulator, in particular a charging and discharging temperature and a charging and discharging current. To this end, it is necessary to obtain correspondingly reliable measurement values from the accumulator.

In the prior art, electrical connections of accumulator cells and battery pack cells inside the accumulator are embodied in the form of separate cell connectors. Particularly in accumulators equipped with a plurality of accumulator cells, this results in a high level of assembly complexity, problems with positioning the cell connectors onto the poles of the accumulator cells, quality problems with the accumulators, and in subsequent use, an increased probability of accumulator failure. In addition, electrical connections of accumulator cells inside the accumulator are as a rule laid out so that the electrical cell connectors do not overlap. This sometimes requires additional cable connections inside the accumulator, which requires an unnecessarily large amount of space inside the accumulator. In this case, particularly short cables that are used to avoid or bypass overlapping of cell connectors are either almost impossible to implement from a technical standpoint or can only be implemented with a high degree of assembly complexity.

The object of the invention is to disclose an improved accumulator. In particular, one object of the invention is on the one hand to obtain measurement values from an interior of the accumulator and on the other hand, to achieve a space-saving electrical cell connection inside the accumulator in which an overlapping of the cell connectors can be allowed and to disclose a rugged and inexpensive accumulator that can be quickly manufactured without losses in quality. Another object of the invention is to achieve an electromechanical tool equipped with an accumulator according to the invention.

The object of the invention is attained by means of an accumulator according to claim 1 and an electromechanical tool according to claim 10.

A cell connector according to the invention for an accumulator according to the invention has an electrical insulation and the electrical insulation is equipped with an electronic component. By means of the electronic component, it is possible, for example, to obtain measurement values from an interior of the accumulator and/or to provide a set of accumulator-protecting electronics inside the accumulator.

In preferred embodiments of the invention, the electronic component is a resistive, inductive, capacitive, or piezoelectric sensor. Preferable examples include temperature sensors, pressure sensors, and magnetic field sensors.

In a preferred embodiment of the invention, the sensor is an NTC temperature sensor that monitors the temperature of a cell connector inside the accumulator by means of a temperature-dependent resistor embodied with a negative temperature coefficient. A temperature monitoring that can be implemented with it protects the accumulator from overloading, which extends the service life of the accumulator. In addition, the temperature monitoring can issue a warning if the accumulator becomes too hot or too cold, which can also be used during an operation of the tool.

The electronic component can be provided in an arbitrary location inside, partially inside, or on the electrical insulation of the cell connector. Particularly when embodied as a temperature sensor, the electronic component is preferably in direct contact with the electrical cell connector or an interior of the accumulator. In particular, this enables temperature information from the interior of the accumulator to be detected quickly, directly, and with very little time delay. In this case, it is preferable for the electronic component to be provided in the vicinity of or as close as possible to a pole of an accumulator cell of the accumulator since the accumulator cells give off the greatest amount of heat at their poles.

According to the invention, an electrical cell bridging, for example, in which a cell connector reaches across and bridges over another in an electrically insulating fashion, can be equipped with the electronic component. In addition, for example, an electrical cell connector frame that has a plurality of cell connectors can be equipped with the electronic component.

The cell connector according to the invention, which produces an electrical contact between accumulator cells or between an accumulator cell and another current-carrying element, preferably has plastic injection molded onto, around, or behind it. It is thus possible to implement cell connectors that are insulated in relation to one another in a very small amount of space. Furthermore, the plastic element on the cell connector can be used to achieve a heat transfer to adjacent housing parts or to the outside, without coming into conflict with norms and regulations regarding touchability of current-carrying parts. This simplifies an assembly of the cell connector on/in the accumulator in that a single component is produced, composed for example of a plurality of cell connectors together with a cell connector frame. According to the invention, the electronic component is provided on the electrical insulation of the cell connector

In addition to obtaining the most direct possible measurement values from an interior of the accumulator, another advantage of the invention is that it takes up no space, or as little space as possible, inside the accumulator.

Other embodiments of the invention ensue from the remaining dependent claims.

The invention will be explained in detail below in conjunction with exemplary embodiments and with reference to the accompanying drawings.

### DRAWINGS

FIG. 1 is a sectional side view of a first embodiment of an electrical cell connector according to the invention and of an accumulator according to the invention;

FIG. 2 is a sectional side view of a second embodiment of the electrical cell connector according to the invention and of the accumulator according to the invention;

FIG. 3 is a perspective view of a cell bridging according to the invention and the accumulator according to the invention;

FIG. 4 is a sectional side view of FIG. 3, in a region of the cell bridging;

FIG. 5 is a sectional top view of an electrical cell connector frame according to the invention and the accumulator according to the invention; and

FIG. 6 is a partially sectional side view of FIG. 5 along the dot-and-dash line in FIG. 5.

The invention will be described in greater detail below in conjunction with an accumulator for hand-held electromechanical tools. The invention is not, however, limited to such hand-held tools, but should apply to accumulators in general. For example, the invention can be used on accumulators for motor vehicles with internal combustion engines or drive units of electrically powered vehicles. It is also possible, for example, to use the invention on accumulators for portable electronic devices, drive units such as those used in model-building, mobile telephones, cameras, and the like.

When the term “cell connector” is used below, it should be understood to also include the term “cell connection” for a pole of the accumulator, i.e. the invention also relates to the section of an accumulator in which the cell connector is visible in the form of an accumulator pole on an outer surface of the accumulator. In addition, dashed lines in the drawing indicate edges that are not visible.

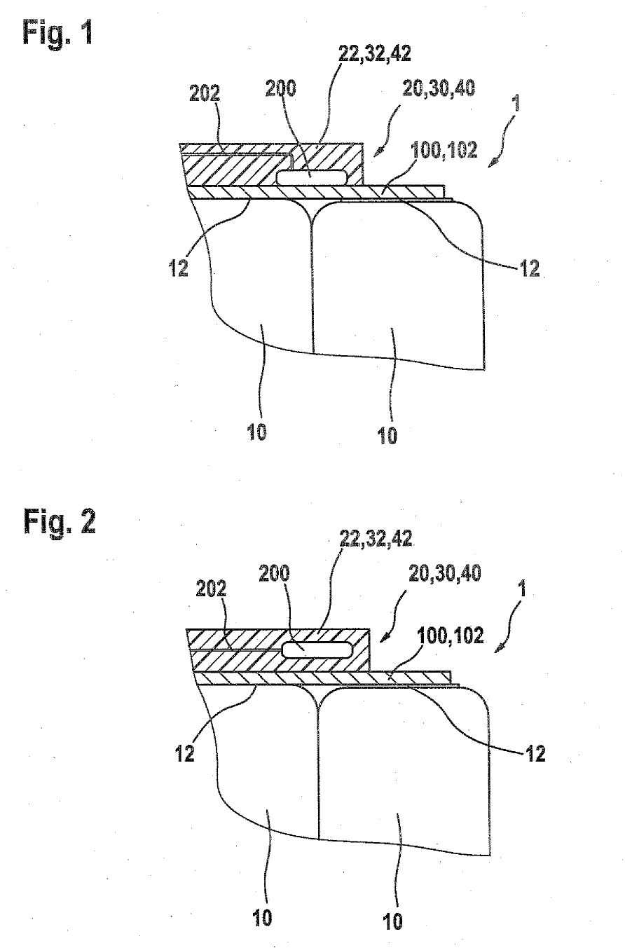

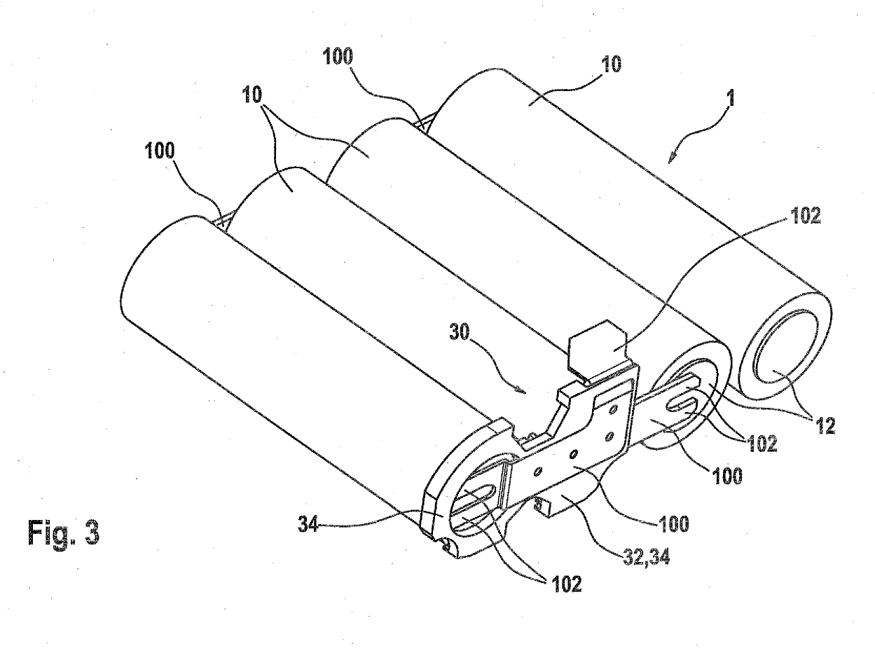

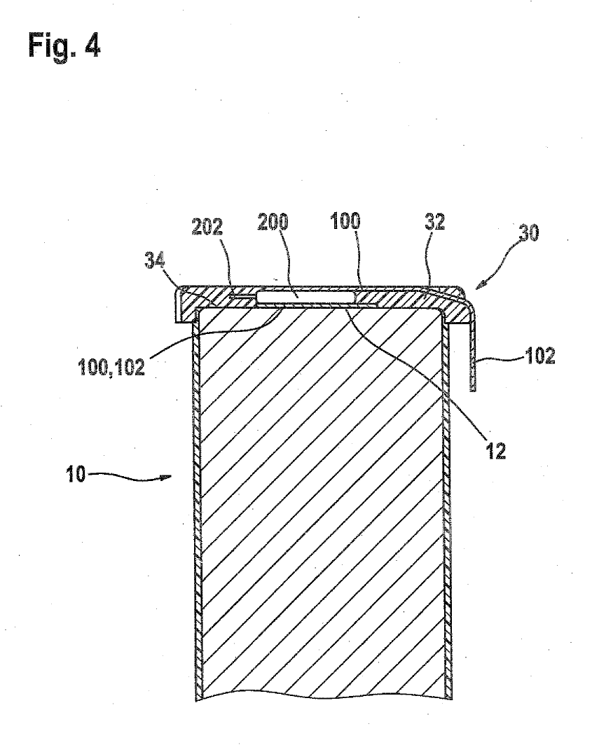

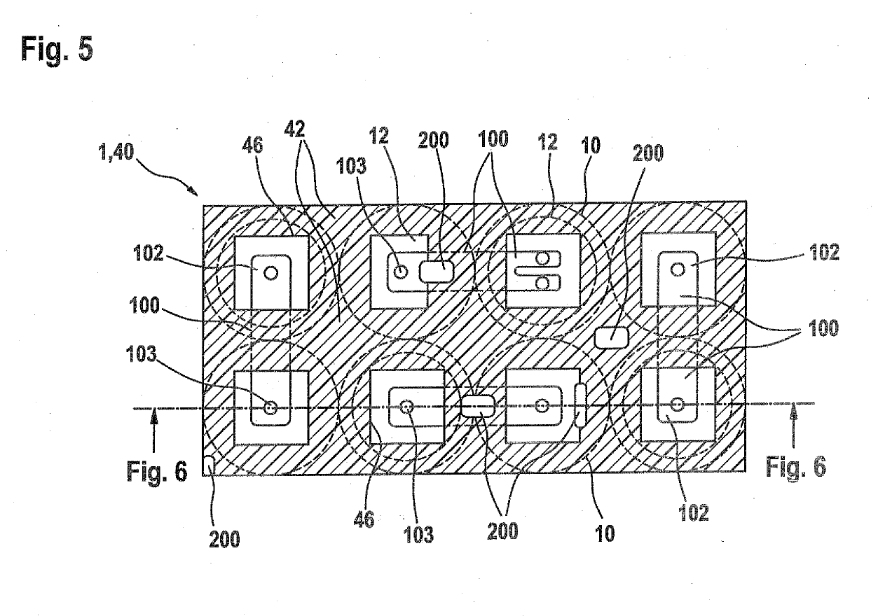

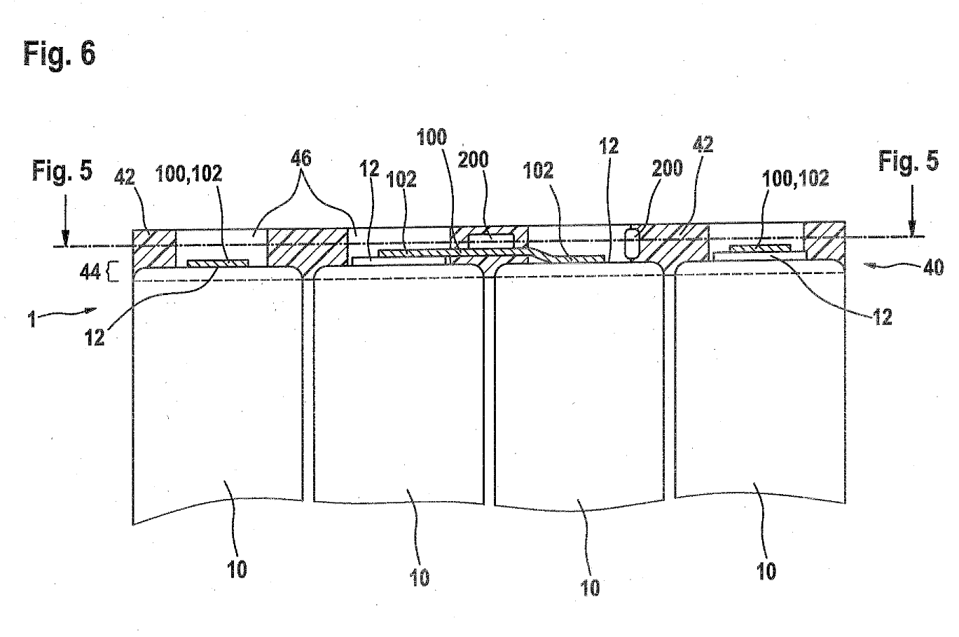

FIGS. 1 and 2 each show a respective embodiment according to the invention of a common electrical cell connection 20 inside an accumulator 1 according to the invention, a battery chain 1, a battery pack 1, or a battery 1; a housing of the accumulator 1 is not shown. In this case, the general form of the cell connection 20 has a preferably flat and preferably band-shaped electrical cell connector 100 on which an electrical insulation 22 is provided. It is possible, for example, for the cell connection 20 to be embodied in the form of an electrical cell bridging 30, which is equipped with an electrical insulation 32 (also see FIGS. 3 and 4), or in the form of an electrical cell connector frame 40 equipped with an electrical insulation 42 (also see FIGS. 5 and 6). The electrical insulation 22, 32, 42 is preferably composed of a plastic and is injection molded onto the cell connector(s) 100, preferably injection molded at least partially around or behind it/them.

FIG. 1 shows the accumulator 1 according to the invention, with a partial depiction of two accumulator cells 10. The two accumulator cells 10 are electrically connected in series by means of the cell connector 100 via their two electrical poles 12. Other electrical wiring schemes are naturally also possible. On a side oriented away from the two poles 12, the cell connector 100 has the electrical insulation 22 that is able to electrically insulate the cell connector 100 in relation to a second cell connector 100, for example, (not shown). However, it is also possible, for example, for this insulation 22 to electrically insulate the cell connector 100 in relation to another electrical conductor.

According to the invention, the electrical insulation 22 has an electronic component 200, e.g. a set of accumulator-protecting electronics 200 or a sensor 200. In the exemplary embodiment shown in FIG. 1, a section of the electronic component 200 has a direct contact with the preferably metallic cell connector 100. In other words, the electrical insulation 22 is used to fasten the electronic component 200 to the cell connector 100. This makes it possible to receive a measurement value from the interior of the accumulator 1. For this purpose, a line 202 leads from the sensor 200 first through the electrical insulation 22 and from there, away toward the housing of the accumulator. In this case, the line 202 can emerge from the housing and lead into a hand-held electromechanical tool (not shown). It is also possible, however, to let the line 200 end in a contact (not shown) on a housing exterior of the accumulator. This contact then contacts another contact inside the tool or inside a charging unit so that the information of the sensor 200 can be conveyed to an evaluation unit.

FIG. 2 shows another exemplary embodiment of the invention in which the electronic component 200 is completely enclosed by the electrical insulation 22. In addition, it is naturally also possible to provide the electronic component 200 in any position in/on the electrical insulation 22 of the cell connector 100. It is thus possible, for example, for the electronic component 200 to protrude from the electrical insulation 22 (also see FIGS. 5 and 6).

The electronic component 200 built into the interior of the accumulator 1 can be any component that is suitable for use in an accumulator 1. It is thus possible, for example, to provide a set of protective electronics 200 that takes care of the entire accumulator 1 or only part of the accumulator cells 10 of the accumulator 1. Other suitable components include sensors 200 that are able to determine certain measurement values such as a temperature, a pressure, or an electrical value. A preferred component in this context is a temperature sensor 200 that is embodied in the form of a contact thermometer. In principle, passive and active sensors 200 are suitable for this. In order to produce a signal, passive sensors require an auxiliary power source that is connected to the sensor 2 via the line 202.

FIGS. 3 and 4 show a use of the invention in an electrical cell bridging 30. This cell bridging 30 has an electrical cell connector 100 that overlaps and reaches across a second cell connector 100. In this case, the electrical insulation 32 separates the cell connector 100 from the other cell connector 100 electrically and also spatially. According to the invention, the electrical insulation 32 fastened to the cell connector 100 is equipped with the electronic component 200. In this case, the electronic component 200, as demonstrated above, can be provided inside the electrical insulation 32. In particular, the electronic component 200 can touch both cell connectors 100, as shown in FIG. 4. In other words, the electrical insulation 32 has a through opening in the region in which the electronic component 200 is to be provided in the electrical insulation 32.

The longitudinal end sections of the electrical cell bridging 30 according to the invention are provided with contact sections 102 that are used to produce an electrical contact. In this case, the contact sections 102 can contact two electrical poles 12, for example, of two different accumulator cells 10 (not shown). In the exemplary embodiment shown, a contact section 102 is embodied in the form of a tab 102 to which another contacting section 102 or an electrical cable (not shown) can be connected.

Preferably, the electrical cell bridging 30 has at least one fastening section 34 by means of which it is able to rest against a pole side of the accumulator cell 10. In this case, the fastening section 34, embodied as the negative form of an end section of an accumulator cell 10, is preferably formed into the electrical insulation 32 of the cell bridging 30. In this case, this formed-in section preferably contains a recess for the contact section 102 of the second cell connector 100, as shown in FIG. 4. Preferably, the cell bridging 30 has a second fastening section 34 that has a through opening through which the contact section 102 of the cell connector 100 of the cell bridging 30 can pass. In this case, this fastening section 34 encompasses the contact section 102 at least in semicircular fashion; the fastening section 34 is preferably composed of the electrical insulation 32 and is formed into the one end section of the accumulator cell 10 that is preferable for a placement onto the accumulator cell(s) 10.

The electrical cell bridging 30 can have recesses, particularly in its corner regions, in order to be able to provide a housing of the accumulator 1 that rests as intimately as possible against an accumulator cell 10.

FIGS. 5 and 6 depict the use of the invention on an electrical cell connector frame 40, which, by means of an electrical insulation 42, secures a plurality of electrical cell connectors 100, preferably in their respective middle regions. This can best be seen in FIG. 6. In the exemplary embodiment shown, eight accumulator cells 10 are electrically connected in series at one end of the accumulator 1 by means of four electrical cell connectors 100. In this case, the relevant contact sections 102 are connected by means of weld points 103 to the relevant poles of the accumulator cells 10 in a mechanically fixed, electrically conductive fashion.

In the other embodiments of the invention, it is likewise preferable if the relevant contact section 102 is connected to the accumulator cell 10 by means of one or two weld points. FIG. 5 also shows a preferred embodiment of a contact section 102 with two tabs that are separated from each other electrically by means of a gap; each tab is attached or welded to a pole 12 of an accumulator cell 10.

For the welding of the contact sections 102 to the accumulator cells 10, the electrical insulation 42 of the cell connector frame 40 has through openings 46 through which a welding tool can access both of the connection partners. The cell connector frame 40 according to the invention makes it possible to avoid having to pre-mount individual cell connectors 100 onto the accumulator cells 12. The cell connector frame 40 is simply placed with its cell connectors 100 onto the accumulator cells 10. In this case, the cell connector frame 40 can have a fastening section 44 that has corresponding recesses and/or projections that secure the cell connector frame 40 to the accumulator cells 10.

According to the invention, the electrical insulation 42 of the cell connector frame 40 is now equipped with the electronic component 200. FIG. 5 shows a plurality of possible positions of the electronic component 200 on or in the electric insulation 42. Thus FIG. 5 shows the electronic component 200 in a middle region of an electrical connector 100, as is also shown in FIG. 6; the electronic component 200 in turn is in direct contact with the cell connector 100 (see FIG. 6). For example, it is also possible, as is likewise shown in FIG. 6, to allow the electronic component 200 to protrude out of the electrical insulation 42 into a through opening 46.

It is also possible, as shown in FIG. 5, to place the electronic component 200 in the middle of four accumulator cells 10. FIG. 5 also shows an electronic component 200 in a corner region of the cell connector frame 40. It is also possible, as can be seen at the top in FIG. 5, to bring the electronic component 200 as close as possible to the welding point 103 between the contact section 102 and the pole 12. It can be preferable if the electronic component 200 protrudes from the electrical insulation 42 into the through opening 46 or is provided in the electrical insulation 42 only after the welding of the contact section 102. It is naturally also possible to use positions other than the ones shown in FIGS. 5 and 6.

1-10. (canceled)

11. An accumulator for hand-held electromechanical tools, comprising:
a plurality of accumulator cells that are electrically connected to one another by means of electrical cell connectors;
at least one cell connector has an electrical insulation; and
an electronic component is provided in or on the electrical insulation.

12. The accumulator as recited in claim 11, wherein the electronic component is in contact with the cell connector and/or is in contact with an interior of the accumulator and/or is completely embedded in the electrical insulation.

13. The accumulator as recited in claim 11, wherein the electronic component is provided between two reciprocally overlapping cell connectors on or in the electrical insulation.

14. The accumulator as recited in claim 12, wherein the electronic component is provided between two reciprocally overlapping cell connectors on or in the electrical insulation.

15. The accumulator as recited in claim 11, wherein the electronic component is a set of accumulator-protecting electronics or a sensor, in particular a resistive sensor, an inductive sensor, a capacitive sensor, or a piezoelectric sensor.

16. The accumulator as recited in claim 12, wherein the electronic component is a set of accumulator-protecting electronics or a sensor, in particular a resistive sensor, an inductive sensor, a capacitive sensor, or a piezoelectric sensor.

17. The accumulator as recited in claim 13, wherein the electronic component is a set of accumulator-protecting electronics or a sensor, in particular a resistive sensor, an inductive sensor, a capacitive sensor, or a piezoelectric sensor.

18. The accumulator as recited in claim 11, wherein the sensor is a temperature sensor, in particular an NTC temperature sensor, a pressure sensor, or a magnetic field sensor.

19. The accumulator as recited in claim 12, wherein the sensor is a temperature sensor, in particular an NTC temperature sensor, a pressure sensor, or a magnetic field sensor.

20. The accumulator as recited in claim 13, wherein the sensor is a temperature sensor, in particular an NTC temperature sensor, a pressure sensor, or a magnetic field sensor.

21. The accumulator as recited in claim 11, wherein the sensor is provided on or in a region of the electrical insulation in which the accumulator is hottest, according to experimental data.

22. The accumulator as recited in claim 14, wherein the sensor is provided on or in a region of the electrical insulation in which the accumulator is hottest, according to experimental data.

23. The accumulator as recited in claim 11, wherein the electronic component is provided on or in an electrical insulation of an electrical cell bridging.

24. The accumulator as recited in claim 22, wherein the electronic component is provided on or in an electrical insulation of an electrical cell bridging.

25. The accumulator as recited in claim 11, wherein the electronic component is provided on/in an electrical insulation of an electrical cell connector frame.

26. The accumulator as recited in claim 24, wherein the electronic component is provided on/in an electrical insulation of an electrical cell connector frame.

27. The accumulator as recited in claim 11, wherein the electrical insulation is composed of a plastic and is injection molded onto the electronic component, preferably injection molded at least partially around or behind it.

28. The accumulator as recited in claim 26, wherein the electrical insulation is composed of a plastic and is injection molded onto the electronic component, preferably injection molded at least partially around or behind it.

29. An electromechanical tool, in particular a cordless screwdriver, power drill, circular saw, jigsaw, grinding machine, or garden appliance equipped with an accumulator as recited in claim 11.

30. An electromechanical tool, in particular a cordless screwdriver, power drill, circular saw, jigsaw, grinding machine, or garden appliance equipped with an accumulator as recited in claim 12.
